(19) United States
(12) Patent Application Publication
(10) Pub. No.: US 2009/0064696 A1
(43) Pub. Date: Mar. 12, 2009

(54) AUTOMOTIVE CLIMATE SYSTEM AND METHOD OF CONTROLLING SAME

(75) Inventor: William Paul Perkins, Dearborn, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/853,206

(22) Filed: Sep. 11, 2007

(51) Int. Cl. B60H 1/32

(52) U.S. Cl. 62/244

(57) ABSTRACT

An alternatively powered vehicle includes electrically powered cabin heaters and coolers. An operator sends a signal to his vehicle instructing the vehicle to bring a cabin temperature to a desired temperature. In response, the vehicle determines whether a battery state of charge exceeds a threshold and if so, activates the appropriate cabin heater or cooler to condition cabin air to the desired temperature.

### BACKGROUND

1. Field of the Invention

The invention relates to automotive climate systems and methods of controlling the same.

2. Discussion

Prior to use, an interior of a vehicle may have an undesirable climate. For example, a vehicle exposed to 100 degree ambient conditions may have similar cabin conditions. Likewise, a vehicle exposed to 0 degree ambient conditions may have similar cabin conditions.

Vehicle climate systems may include an air conditioner that is driven by a belt mechanically coupled to an output shaft of an engine. To operate the air conditioner, the engine must be on. Vehicle climate systems may also use heat generated by the engine to heat cabin air.

### SUMMARY

Embodiments of the invention may take the form of a climate system for a vehicle. The system includes an electrically powered climate unit, an energy storage unit, and a controller configured to issue a command, in response to a signal, to provide electrical power from the energy storage unit to the electrically powered climate unit.

Embodiments of the invention may take the form of a climate system for a vehicle. The system includes a power system configured to receive electrical power from an external power outlet, an electrically powered climate unit configured to alter a temperature associated with the cabin and to receive electrical power from the external power outlet via the power system, and a receiver configured to receive a signal generated remote from the vehicle. The system also includes a controller configured to issue a command, in response to the signal, to provide electrical power from the external power outlet to the electrically powered climate unit.

Embodiments of the invention may take the form of a method for controlling a climate system of a vehicle. The method includes receiving a signal generated remote from the vehicle, issuing a command, in response to the signal, to provide electrical power from an energy storage unit to an electrically powered climate unit, and providing electrical power, in response to the command, from the energy storage unit to the electrically powered climate unit.

While exemplary embodiments in accordance with the invention are illustrated and disclosed, such disclosure should not be construed to limit the claims. It is anticipated that various modifications and alternative designs may be made without departing from the scope of the invention

### BRIEF DESCRIPTION OF THE DRAWINGS

FIG. 1 is a schematic diagram of an example power system for a vehicle.

FIG. 2 is a flow chart of an example strategy for controlling a power system of a vehicle.

### DETAILED DESCRIPTION

A vehicle, e.g., a hybrid electric vehicle, a conventional vehicle, in accordance with embodiments of the invention includes electrically powered climate units, e.g., heaters, coolers, etc., that may receive power from one or more high voltage batteries. These electrically powered climate units may be used, for example, to heat or cool cabin air and may be activated remotely. As such, a driver may condition the interior of the vehicle to a desired temperature prior to entering the vehicle. For example, a driver may send a signal to his plug-in hybrid electric vehicle via cell phone instructing the vehicle to bring the interior temperature to 72 degrees and to activate heated seat and steering wheel features. The vehicle, in response to the signal, checks the battery state of charge to ensure that there is sufficient power to start the vehicle after operating the climate unit and if so, activates an electrically powered heater and heated seat and steering wheel features.

Control systems communicate with devices remote from the vehicle and permit electrically powered climate devices to access electrical energy. This electrical energy may be provided by a storage unit, e.g., battery, or a supply line, e.g., utility grid. This access may occur when, for example, a vehicle engine, if present, is off.

Some control systems may restrict access to electrical energy based on parameters associated with the vehicle. For example, a control system may measure interior conditions of a vehicle and permit access to electrical energy if the interior conditions fall outside some predefined limits. Likewise, a control system may assess the condition of any storage unit or supply line of electrical power and permit access to electrical energy if the condition of such storage unit and/or supply line meets some predefined criteria.

Various strategies may be implemented to control electrically powered climate units that receive power from a battery and/or remote power source. For example, a climate unit may start if the measured cabin temperature is below a preset climate control setting. A climate unit may turn off, once activated, if a door is not opened within a predetermined time period, e.g., 6 minutes. A horn may beep if the climate unit starts in response to a remote signal to provide audible feedback to the requester.

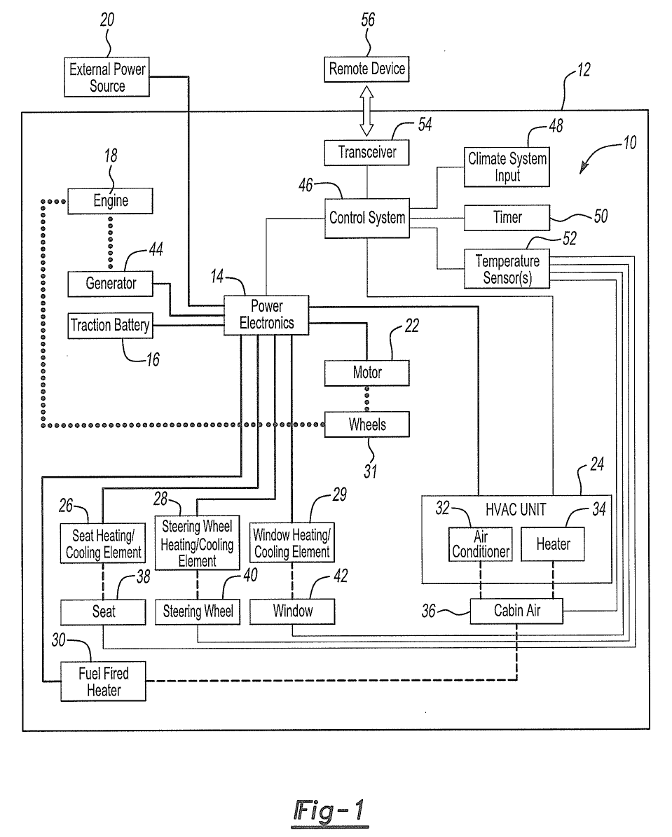

FIG. 1 is a schematic diagram of example power system 10 of plug-in hybrid electric vehicle 12. Other vehicles, e.g., hybrid electric vehicles, electric vehicles, hybrid fuel cell vehicles, conventional vehicles, etc., may also employ the systems and methods discussed herein. The flow of energy, in various forms, between blocks of the diagram is represented by heavy line. The flow of information, in various forms, between blocks of the diagram is represented by light line.

Power electronics 14, e.g., intelligent circuitry, power converters, etc., of FIG. 1 receives power, as indicated by solid heavy line, from battery 16, e.g., traction battery, generator 44, and/or external power source 20, e.g., power outlet. Power electronics 14 conditions this power and distributes it to motor 22, HVAC unit 24, seat heating/cooling element 26, e.g., Peltier device, Seebeck device, etc., steering wheel heating/cooling element 28, window heating/cooling element 29, and/or fuel fired heater 30. For example, power electronics 14 receives high voltage, direct current power from battery 16 and converts it to low voltage, alternating current for use by seat heating/cooling element 26. In other embodiments, power electronics 14 may distribute power to different climate units, e.g., electrically powered foot heater, etc.

Motor 22 of FIG. 1 converts electrical power received from power electronics 14 into mechanical power, as indicated by dotted heavy line, to move wheels 31.

HVAC unit 24 of FIG. 1 includes air conditioner 32 and heater 34. Power received by HVAC unit 24 from power electronics 14 may be used by either of air conditioner 32 and heater 34. For example, air conditioner 32 may use such power to cool cabin air 36, as indicated by dashed heavy line. Similarly, heater 34 may use such power to heat cabin air 36, as indicated by dashed heavy line.

Power received by seat heating/cooling element 26 from power electronics 14 may be used to heat or cool seat 38, as indicated by dashed heavy line. Power received by steering wheel heating/cooling element 28 may be used to heat or cool steering wheel 40, as indicated by dashed heavy line. Power received by window heating/cooling element 29 may be used to heat or cool window 42, as indicated by dashed heavy line. Power received by fuel fired heater 30 may be used to heat cabin air 36, as indicated by dashed heavy line.

Mechanical power generated by engine 18, as indicated by dotted heavy line, may be converted by generator 44 to electrical power. Power electronics 14 may store this electrical power in battery 16 or may distribute it as discussed above. Mechanical power generated by engine 18, as indicated by dotted heavy line, may also be used to move wheels 31.

Control system 46, e.g., one or more controllers, vehicle system controller, etc., controls power electronics 14 in part to accomplish the power distribution discussed above. Control system 46 communicates with power electronics 14 via controller area network (CAN), or other communications protocol, as indicated by light line. This communicative relationship between control system 46 and power electronics 14 permits control system 46 to, for example, determine the state of charge of battery 16. As discussed below, control system 46 issues commands to power electronics 14 such that, for example, power electronics 14 selectively provides power from battery 16 to HVAC unit 24 while engine 18 is off.

Control system 46 communicates with climate system input 48, e.g., dials, buttons, etc., timer 50, temperature sensor(s) 52, and transceiver 54 via CAN, or other communications protocol, as indicated by light line. An occupant of vehicle 12 may input a desired interior temperature, e.g., 78 degrees, and as discussed below, when activated, control system 46 may control power electronics 14 such that HVAC unit 24 brings the interior temperature to 78 degrees. Additionally, when activated, control system 46 may activate timer 50. Timer 50 prevents, for example, control system 46 from controlling power electronics 14 for extended periods of time. For example, timer 50 may expire after 5 minutes. At the expiration of timer 50, control system 46 may deactivate power electronics 14. Such deactivation may prevent power electronics 14 from draining battery 16 below a minimum threshold necessary to start the vehicle.

Temperature sensor(s) 52 sense the temperature of cabin air 36, seat 38, steering wheel 40, and window 42. Control system 46 reads the measured temperatures and communicates this information to transceiver 54. Transceiver 54 may transmit information regarding the measured temperatures. Likewise, transceiver 54 may transmit information regarding, for example, the on/off status of HVAC unit 24.

Remote device 56, e.g., key fob, cell phone, computer, PDA, etc., may receive and display information transmitted from transceiver 54. For example, remote device 56 may receive information from transceiver 54 regarding the temperature of cabin air 36. Remote device 56 may also transmit information to transceiver 54. For example, before entering vehicle 12, a driver may transmit a command to transceiver 54 directing control system 46 to control power electronics 14 such that electrical power from battery 16 is distributed to window heating/cooling element 29 thus heating/cooling window 42. A driver may also transmit a command to transceiver 54 directing control system 46 to control power electronics 14 such that such that electrical power from battery 16 is no longer distributed to window heating/cooling element 29.

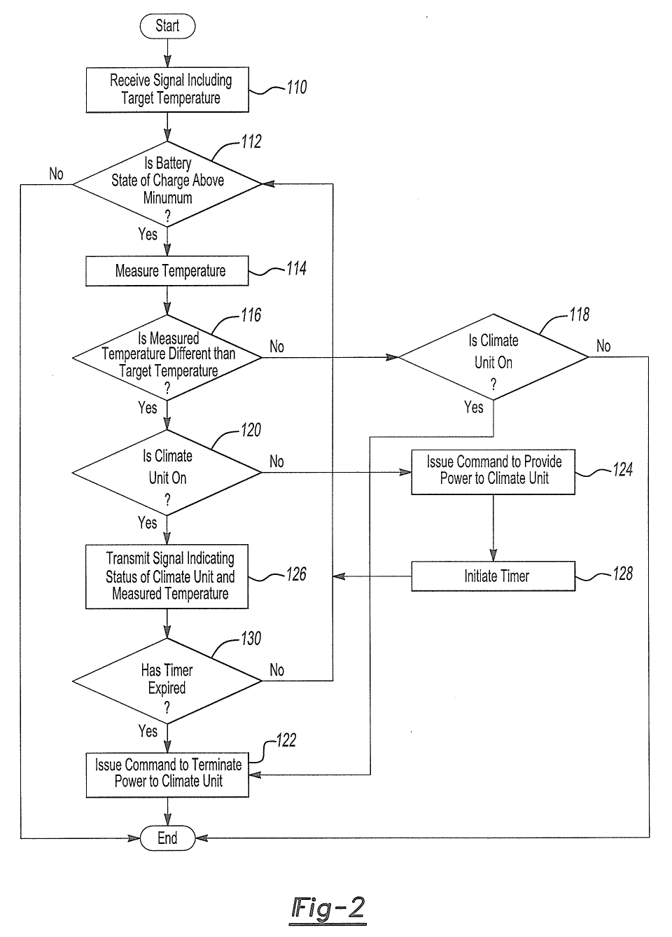

FIG. 2 is a flow chart of a strategy for controlling power system 10. At 110, a signal is received including a target temperature. For example, controller 46 receives information from remote device 56 via transceiver 54. This information includes a command to activate heater 34 and a target temperature of 75 degrees. In other embodiments, an occupant may pre-select the desired climate settings via, for example, climate system input 48. In such embodiments, target temperature information need not be included in the information received from remote device 56.

At 112, it is determined whether the battery state of charge is above a minimum. For example, controller 46 determines if the state of charge of battery 16 is above 40%. If no, the strategy ends as battery 16 may have insufficient charge to, for example, start engine 18 via generator 44. If yes, the strategy proceeds to 114.

At 114, a temperature is measured. For example, temperature sensor(s) 52 measures the temperature of cabin air 36. Control system 46 then reads this measured temperature information.

At 116, it is determined whether the measured temperature is different than the target temperature. For example, control system 46 compares the measured temperature, e.g., 40 degrees, with the target temperature, e.g., 75 degrees. If no, the strategy proceeds to 118. If yes, the strategy proceeds to 120.

At 118, it is determined whether the climate unit is on. For example, control system 46 determines whether HVAC unit 24 including heater 34 is on. If no, the strategy ends as the measured temperature and target temperature are not different and the climate unit is off. If yes, the strategy proceeds to 122.

At 122, a command is issued to terminate power to the climate unit. For example, control system 46 may set a flag associated with power electronics 14 to zero such that, for example, power electronics 14 no longer distributes power. The strategy then ends.

At 120, it is determined whether the climate unit is on. For example, control system 46 determines whether HVAC unit 24 including heater 34 is on. If no, the strategy proceeds to 124. If yes, the strategy proceeds to 126.

At 124, a command is issued to provide power to the climate unit. For example, control system 46 issues a command to power electronics 14 such that power electronics 14 supplies power from battery 16 to HVAC unit 24 including heater 34.

At 128, a timer is initiated. For example, control system 46 starts timer 50. The strategy then returns to 112.

At 126, a signal is transmitted indicating the status of the climate unit and measured temperature. For example, transceiver 54 transmits information indicating that HVAC unit 24 is on and regarding the measured temperature, e.g., 40 degrees.

At 130, it is determined whether the timer has expired. For example, control system 46 determines whether timer 50 has expired. If no, the strategy returns to 112. If yes, the strategy proceeds to 122.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A climate system for a vehicle including a cabin, the system comprising:
an electrically powered climate unit configured to alter a temperature associated with the cabin;
an energy storage unit configured to provide electrical power for the electrically powered climate unit;
a receiver configured to receive a signal generated remote from the vehicle; and
a controller configured to issue a command, in response to the signal, to provide electrical power from the energy storage unit to the electrically powered climate unit.

2. The system of claim 1 wherein the vehicle further includes an engine having an on state and an off state and wherein the controller is further configured to issue the command while the engine is in the off state.

3. The system of claim 1 wherein the energy storage unit is further configured to provide motive power for the vehicle.

4. The system of claim 1 further comprising a transmitter wherein the controller is further configured to determine a status of the electrically powered climate unit and wherein the transmitter is configured to transmit a signal indicative of the status of the electrically powered climate unit.

5. The system of claim 1 further comprising a transmitter and a temperature sensor to measure the temperature associated with the cabin wherein the controller is further configured to read the measured temperature from the temperature sensor and wherein the transmitter is configured to transmit a signal indicative of the measured temperature.

6. The system of claim 1 wherein the electrically powered climate unit comprises at least one of an air conditioning system, a heating system, a fuel fired heater, a resistive coil heater, a thermo-electric heater, a thermo-electric cooler, a convective heater, and a convective cooler.

7. The system of claim 1 wherein the cabin includes a seat, a window, a steering wheel, and air and wherein the temperature associated with the cabin comprises at least one of a temperature of the seat, a temperature of the window, a temperature of the steering wheel, and a temperature of the air.

8. A climate system for a vehicle including a cabin, the system comprising:
a power system configured to receive electrical power from an external power outlet;
an electrically powered climate unit configured to alter a temperature associated with the cabin and to receive electrical power from the external power outlet via the power system;
a receiver configured to receive a signal generated remote from the vehicle; and
a controller configured to issue a command, in response to the signal, to provide electrical power from the external power outlet to the electrically powered climate unit.

9. The system of claim 8 wherein the vehicle further includes an engine having an on state and an off state and wherein the controller is further configured to issue the command while the engine is in the off state.

10. The system of claim 8 further comprising a transmitter wherein the controller is further configured to determine a status of the electrically powered climate unit and wherein the transmitter is configured to transmit a signal indicative of the status of the electrically powered climate unit.

11. A method for controlling a climate system of a vehicle, the vehicle including a cabin, an electrically powered climate unit to alter a temperature associated with the cabin, and an energy storage unit, the method comprising:
receiving a signal generated remote from the vehicle;
issuing a command, in response to the signal, to provide electrical power from the energy storage unit to the electrically powered climate unit; and
providing electrical power, in response to the command, from the energy storage unit to the electrically powered climate unit.

12. The method of claim 11, wherein the vehicle further includes an engine having an on state and an off state and wherein the electrical power is provided from the energy storage unit to the electrically powered climate unit while the engine is in the off state.

13. The method of claim 11, wherein the vehicle further includes an engine having an on state and an off state, further comprising providing power generated by the engine to the electrically powered climate unit.

14. The method of claim 11 further comprising determining a state of charge of the energy storage unit wherein the electrical power is provided from the energy storage unit to the electrically powered climate unit if the state of charge exceeds a predetermined threshold.

15. The method of claim 11 wherein the command is terminated after a predetermined period of time.

16. The method of claim 11 further comprising determining a status of the electrically powered climate unit and transmitting a signal indicative of the status.

17. The method of claim 11 further comprising measuring the temperature associated with the cabin and transmitting a signal indicative of the measured temperature.

18. The method of claim 11 further comprising measuring the temperature associated with the cabin wherein the command is based on the measured temperature.

19. The method of claim 11 wherein the signal includes information indicative of a climate setting and wherein the command is based on the information indicative of a climate setting.

20. The method of claim 19 further comprising suspending the command when the climate setting is achieved.
